(19) United States
(12) Patent Application Publication
(10) Pub. No.: US 2022/0325576 A1
(43) Pub. Date: Oct. 13, 2022

(54) CORD WINDING ASSEMBLY WITH SLIDING GUIDE MEMBER AND WINDOW BLIND USING THE CORD WINDING ASSEMBLY

(71) Applicant: CHING FENG HOME FASHIONS CO., LTD., CHANG-HUA (TW)

(72) Inventors: SHENG-YING HSU, CHANG-HUA (TW); MING-CHU CHIANG, CHANG-HUA (TW)

(21) Appl. No.: 17/322,857

(22) Filed: May 26, 2021

(30) Foreign Application Priority Data
Apr. 12, 2021 (TW) 110113101

(51) Int. Cl. E06B 9/322

(52) U.S. Cl. CPC E06B 9/322; E06B 2009/3225; E06B 9/323

(57) ABSTRACT

A window blind includes a headrail, a control device mounted in the headrail, a rotating rod, a blind body, a bottom rail, two lift cords, and two cord winding assemblies mounted on the rotating rod. Subject to the technical feature that the lift cords have the respective one ends thereof connected to the sliding guides of the respective cord winding assemblies and the respective other ends thereof extending along the respective lead angle sections of the respective openings of the respective rotating members and connected to the respective cord insertion holes of the headrail, when the blind body is in the unfolded or folded state, the clamping force produced on the lift cords between the sliding guides and the openings of the respective rotating members can be reduced, preventing the lift cords from being pushed down to break, which greatly increases the service life of the window blind.

### BACKGROUND OF THE INVENTION

### 1. Field of the Invention

The present invention relates to window blind winding technology and more particularly, to a cord winding assembly with a sliding guide and a window blind using the cord winding assembly.

### 2. Description of the Related Art

At present, there are many kinds of cord winding assemblies used on window blinds, and their purpose is to facilitate the user to adjust the indoor lighting, ventilation or concealment, etc. That is, as the “Window blind cord winding structure” disclosed in the Republic of China New Patent Announcement No. TWM344112U (the following numbers refer to the numbers listed in the embodiments of the aforementioned patent cases), which comprises a reel seat (10), a reel rod (20), a sliding guide (30), a winding cord (40) and a mounting bracket (50). The winding cord (40) is inserted through a cord hole (33) of the sliding guide (30) and tied to the sliding guide (30). The sliding guide (30) is set in a sliding groove (22) of the real rod (20) by a bump (32). The combined real rod (20), sliding guide (30) and winding cord (40) are buckled at a position-limiting groove (11) of the real seat (10) with the both ends (21) of the real rod (20). The opening of the mounting bracket (50) is clamped downward in the fixing groove (13) of the real seat (10), so that the mounting bracket (50) is buckled with the real rod (20), and the positioning block (51) buckle on the real seat (10). At this time, the winding cord (40) is fixed to the cord hole (33) of sliding guide (30) after passing through the cord guide hole (12) of the real seat (10) along the circumference of the pulley (14) of the real seat (10). When the winding cord (40) is to be wound, the real rod (20) is rotated so that the sliding guide (30) stuck in the sliding groove (22) of the real rod (20) and the rod (20) are rotated synchronously to pull the winding cord (40), making the winding cord (40) loop around the real rod (20). At this time, as the number of turns of the winding cord (40) on the real rod (20) increases, a force for pushing the sliding guide (30) toward the other end (21) of the real rod (20) is gradually produced. In this way, the space in which the winding cord (40) can be wound on the real rod (20) can be increased, thereby achieving the effect of winding. When you want to release the winding cord (40) that has been wound on the real rod (20), the end of the winding cord (40) at the cord guide hole (12) of the real seat (10) is subjected to an external force to generate a pull-down force, so that the winding cord (40) then drives the real rod (20) and the sliding guide (30) to rotate on the real seat (10) synchronously. At this time, the number of turns of the winding cord (40) originally wound on the real rod (20) is gradually reduced by the external force, and the sliding guide (30) can gradually slides again on the real rod (20) to the end near the mounting bracket (50).

The “Window blind cord winding structure” disclosed in the aforementioned patent case can achieve the following effects: 1. With the technical feature of the sliding guide (30) embedded on the real rod (20) and moved towards the reset, it is effective to prevent the winding cord (40) from detaching from the real rod (20). 2. When the winding cord (40) is almost completely pulled out of the real seat (10), because the sliding guide (30) abuts against one side of the mounting bracket (50) at the real seat (10), it will be able to effectively achieve the effect of buffering.

However, the “Window blind cord winding structure” disclosed in the aforementioned patent case still needs improvement. Although when the winding cord (40) is almost completely pulled out of the real seat (10), because the sliding guide (30) abuts against the mounting bracket (50) at the real seat (10), the technical characteristics can achieve a buffering effect, but because the winding cord (40) is fixed to the sliding guide (30), the winding cord (40) is also clamped between the sliding guide (30) and the mounting bracket (50) at this time. Repeating the operation in this way will make the winding cord (40) fixed on the sliding guide (30) between the sliding guide (30) and the mounting bracket (50) to be more prone to breakage.

### SUMMARY OF THE INVENTION

The present invention has been accomplished under the circumstances in view. It is the main object of the present invention to provide a window blind (for example, a honeycomb blind or organ blind), which includes a cord winding assembly used to prevent the lift cord of the window blind from breaking when the lift cord is wound up through the cord winding assembly.

To achieve this and other objects of the present invention, a window blind comprises a headrail, a control device, a rotating rod, a pivoting drive, a blind body, a bottom rail, two lift cords and two cord winding assemblies. Each cord winding assembly comprises a base, a rotating member and a sliding guide. The base comprises a first pivot portion, a second pivot portion, and a cord winding hole cut through a bottom side thereof and disposed close to the first pivot portion. The rotating member is a long hollow tube member configured to form an outer peripheral wall and an inner peripheral wall. The outer peripheral wall comprises a large-diameter end and a small-diameter end respectively pivoted to the first pivot portion and the second pivot portion of the base. The outer peripheral wall of the rotating member is recessed in the direction of the inner peripheral wall to form a guide sliding portion and an opening communicating with the guide sliding portion. The guide sliding portion is connected to the outside world through the opening. The peripheral wall of the aperture of the opening that is close to the large-diameter end forms a lead angle section. The sliding guide is pivoted on the guide sliding portion of the rotating member. The control device of the window blind is installed on one end of the headrail. The rotating rod, the pivoting drive and the two cord winding assemblies are all contained in the headrail. The control device is electrically connected to a micro-control unit in the pivoting drive so that the pivoting drive is electrically controlled by the micro-control unit. The rotating rod has one end thereof connected to the pivoting drive and pivotable by the pivoting drive, and an opposite end thereof inserted through the rotating members of the two cord winding assemblies, so that the two rotating members of the two cord winding assemblies are driven by the rotation of the pivoting drive to drive the rotating rod to rotate accordingly. The blind body has one side thereof connected to the headrail. The bottom rail is connected to the other side of the blind body. Thus, the blind body is between the headrail and the bottom rail. The two lift cords each have one end thereof tied to the sliding guide of one respective cord winding assembly, and an opposite end thereof extending along the lead angle section of the opening of the respective rotating members and passing through a cord insertion hole of the headrail and the blind body and then fixed on the bottom rail.

Subject to the technical feature that the lift cords have the respective one ends thereof connected to the sliding guides of the respective cord winding assemblies and the respective other ends thereof extending along the respective lead angle sections of the respective openings of the respective rotating members and connected to the respective cord insertion holes of the headrail, when the blind body of the window blind is in the unfolded state or the folded state, the clamping force produced on the lift cords between the sliding guides and the openings of the respective rotating members can be reduced, preventing the lift cords from being pushed down to break, which greatly increases the service life of the window blind.

In addition, the present invention provides another window blind (e.g., venetian blind), which comprises the cord winding assembly as disclosed above, and similarly, it can prevent the lift cords of the window blind from breaking when the lift cords wound up through the respective cord winding assemblies.

This another type of window blind comprises a headrail, a control device, a rotating rod, a pivoting drive, a blind body, a bottom rail, two lift cords, two tilt cords and two cord winding assemblies as disclosed above. Each cord winding assembly comprises a base, a rotating member and a sliding guide. The base comprises a first pivot portion, a second pivot portion, and a cord winding hole cut through a bottom side thereof and disposed close to the first pivot portion. The rotating member is a long hollow tube member configured to form an outer peripheral wall and an inner peripheral wall. The outer peripheral wall comprises a large-diameter end and a small-diameter end respectively pivoted to the first pivot portion and the second pivot portion of the base. The outer peripheral wall of the rotating member is recessed in the direction of the inner peripheral wall to form a guide sliding portion and an opening communicating with the guide sliding portion. The guide sliding portion is connected to the outside world through the opening. The peripheral wall of the aperture of the opening that is close to the large-diameter end forms a lead angle section. The sliding guide is pivoted on the guide sliding portion of the rotating member. The control device is installed on one end of the headrail. The rotating rod, the pivoting drive and the two cord winding assemblies are all contained in the headrail. The control device is electrically connected to a micro-control unit in the pivoting drive so that the pivoting drive is electrically controlled by the micro-control unit. The rotating rod has one end thereof connected to the pivoting drive and pivotable by the pivoting drive, and an opposite end thereof inserted through the rotating members of the two cord winding assemblies. The blind body has one side thereof connected to the headrail. The bottom rail is connected to the other side of the blind body. Thus, the blind body is disposed between the headrail and the bottom rail. The two lift cords each have one end thereof tied to the sliding guide of one respective cord winding assembly and an opposite end thereof extending along the lead angle section of the opening of the respective rotating members and passing through a respective cord insertion hole of the headrail and the blind body and then fixed on the bottom rail. The position of the outer peripheral wall of the rotating member of each cord winding assembly close to the respective large-diameter end is recessed to form a position-limiting portion. Each tilt cord has one end thereof connected to the position-limiting portion of the rotating member of one respective cord winding assembly, and an opposite end thereof inserted through the cord insertion hole of the headrail and connected to a plurality of slats of the blind body and fixed to the bottom rail.

### BRIEF DESCRIPTION OF THE DRAWINGS

FIG. 1 is a perspective view of a window blind in an unfolded state in accordance with a first embodiment of the present invention.

FIG. 2 is a partially exploded perspective of the window blind shown in FIG. 1.

FIG. 3 is a sectional view taken along line A-A FIG. 1.

FIG. 4 is a sectional view taken along line B-B of FIG. 1.

FIG. 5 is a schematic drawing of part of the components of FIG. 1, which mainly reveals the connection relationship between a rotating member and a lift cord.

FIG. 6 is a schematic side view of FIG. 5.

FIG. 7 is a schematic perspective view of the first embodiment of the present invention, showing the window blind in a folded state.

FIG. 8 is a schematic cross-sectional view of part of the components of FIG. 7.

FIG. 9 is an oblique top elevational view of a window blind in an unfolded state in accordance with a second embodiment of the present invention.

FIG. 10 is a schematic cross-sectional view of part of the components of FIG. 9.

### DETAILED DESCRIPTION OF THE INVENTION

The applicant first states here that throughout the specification, including the preferred embodiment described below and the claims in the scope of patent application, the terms related to directionality are based on the directions in the drawings. Secondly, in the preferred embodiment and drawings to be described below, the same element numbers represent the same or similar elements or their structural features. Moreover, the detailed structure, characteristics, assembly or use, manufacturing and other methods of the present invention will be described in the detailed description of the subsequent embodiments. However, those with ordinary knowledge in the field of the present invention should be able to understand that these detailed descriptions and the examples listed in the present invention are only used to support the explanation that the present invention can actually be implemented, and are not intended to limit the patent scope of the present invention.

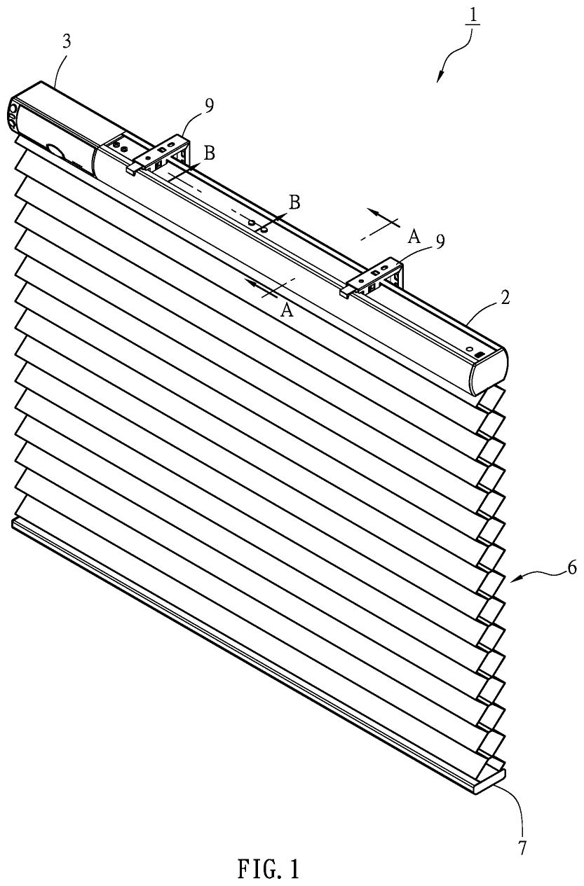

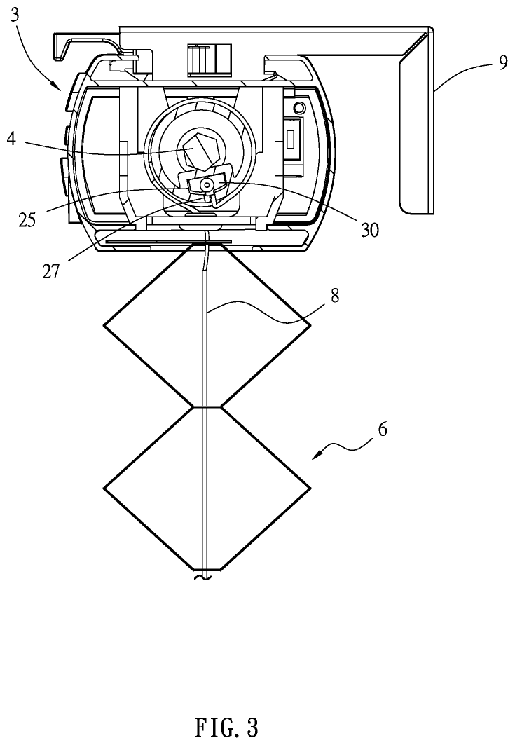

Please refer to FIGS. 1 to 3, which are a window blind 1 (for example, a honeycomb blind, or an organ curtain) disclosed in the first preferred embodiment of the present invention. The window blind 1 comprises a headrail 2, a control device 3 (for example, the control device contains an internal power supply unit), a rotating rod 4, a pivoting drive 5, a blind body 6, a bottom rail 7, two lift cords 8, two mounting brackets 9, and two cord winding assemblies 10. The control device 3 is installed on one end of the headrail 2. The rotating rod 4, the pivoting drive 5 and the two cord winding assemblies 100 are all contained in the headrail 2. The control device 3 is electrically connected to a micro-control unit 51 in the pivoting drive 5 through an electrical wire 301, and the pivoting drive 5 is electrically controlled by the micro-control unit 51 to generate a pivoting movement. One end of the rotating rod 4 is connected to the pivoting drive 5 and is pivoted by the pivoting drive 5 to produce movement. The other end of the rotating rod 4 is sequentially inserted through the two tube-like rotating members 20 of the two cord winding assemblies 100, so that the two rotating members 20 of the two cord winding assemblies 100 are driven by the rotation of the pivoting drive 5 to drive the rotating rod 4 to rotate accordingly. One side of the blind body 6 is connected to the bottom of the headrail 2, and the bottom rail 7 is connected to the other side of the blind body 6, so that the blind body 6 is between the headrail 2 and the bottom rail 7. The two lift cords 8 have the respective one ends thereof respectively tied to the two cord winding assemblies 100, and the respective other ends thereof respectively fixed to the bottom rail 7 after passing through the bottom of the headrail 2 and the blind body 6. The two mounting brackets 9 are separately attached to the headrail 2 and used to provide the headrail 2 to be fixed on the external wall or window frame. It is worth mentioning that the system can only set one mounting bracket 9.

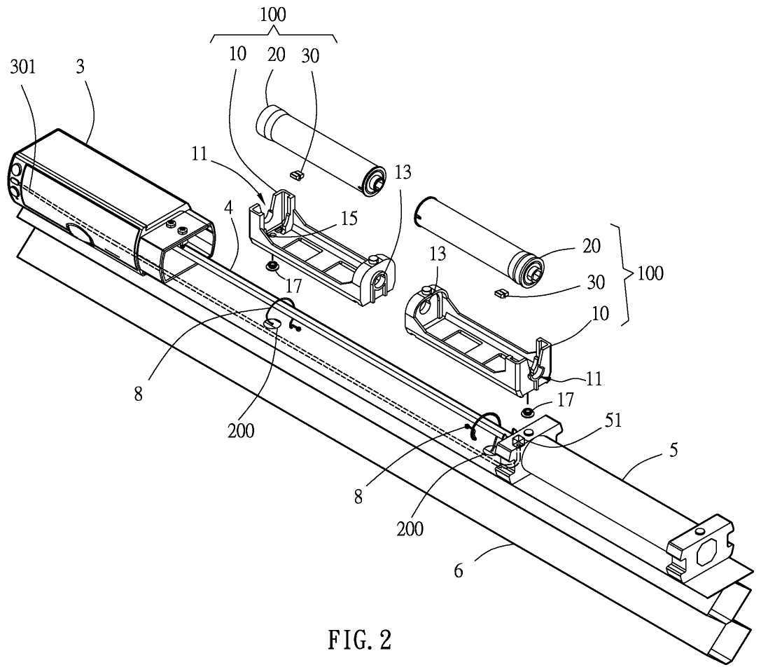

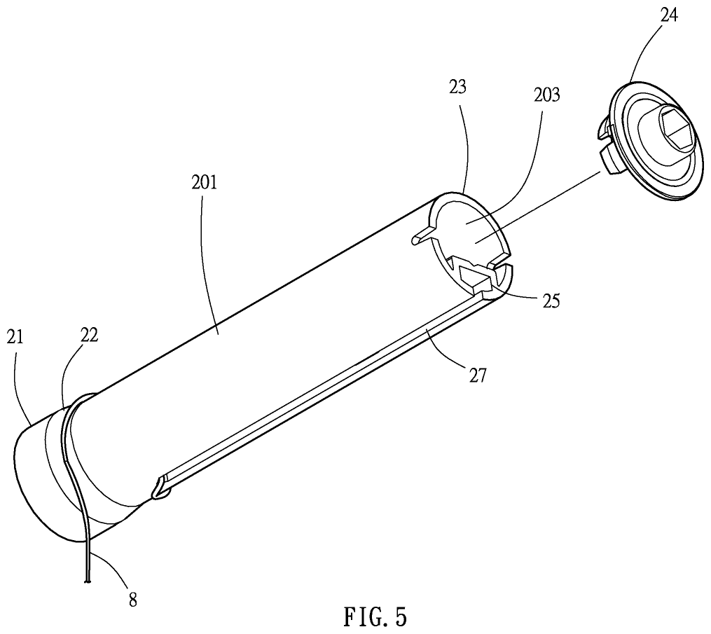

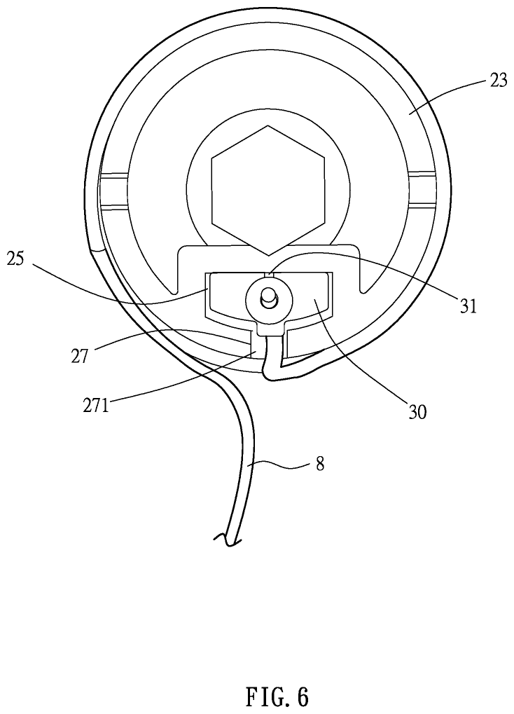

Please also refer to FIGS. 2 to 6, which are the two cord winding assemblies 100 of the honeycomb blind 1 disclosed in the first preferred embodiment of the present invention. Any one of the cord winding assemblies 100 comprises a long base 10, a long rotating member 20 cooperating with the base 10 and a sliding guide 30.

One end of the base 10 is provided with a first pivot portion 11 that opens upwards, the other end of the base 10 is provided with a second pivot portion 13, and the bottom of the base 10 is provided with a cord winding hole 15. The two cord winding holes 15 of the two bases 10 correspond to the positions of the two cord insertion holes 200 provided at the bottom of the headrail 2, and the two cord winding holes 15 of the two bases 10 are respectively mounted with a ring-shaped cord guide 17.

The rotating member 20 is a long hollow tube body and forms an outer peripheral wall 201 and an inner peripheral wall 203. The tubular rotating member 20 comprises a large-diameter end 21, a cord-guide segment 22, a small-diameter end 23 and a cap 24. The large-diameter end 21 and small-diameter end 23 of the rotating member 20 are respectively pivoted to the first pivot portion 11 and the second pivot portion 13 of the base 10. Preferably, the cap 24 is overlaid on the small-diameter end 23. The rotating member 20 is pivoted at the position of the second pivot portion 13 of the base 10 by the cap 24. The cord-guide segment 22 of the rotating member 20 surrounds the outer peripheral wall 201 and is connected to the large-diameter end 21. Preferably, the cord-guide segment 22 gradually converges from the large-diameter end 21 toward the small-diameter end 23, and the large-diameter end 21 of the rotating member 20 is close to the cord winding hole 15 of the base 10. The outer peripheral wall 201 of the rotating member 20 is recessed in the direction of the inner peripheral wall 203 to form a guide sliding portion 25 and an opening 27 communicating with the guide sliding portion 25. The guide sliding portion 25 is concave along the long axis of the rotating member 20. The opening 27 is an elongated opening extended from the small-diameter end 23 toward the large-diameter end 21, so that the guide sliding portion 25 is connected to the outside world through the opening 27. The peripheral wall of the aperture of the opening 27 that is close to the large-diameter end 21 forms a lead angle section 271. The sliding guide 30 is movably pivoted at the position of the guide sliding portion 25 of the rotating member 20, so that the sliding guide 30 can be moved in the guide sliding portion 25 along the longitudinal axis of the rotating member 20. The sliding guide 30 is provided with a knot hole 31.

The above are the technical features of the two cord winding assemblies 100 and their respective components of the window blind 1 disclosed in the first preferred embodiment of the present invention. Please refer to FIGS. 1 to 6 together, which reveal the two cord winding assemblies 100 set on the window blind 1 and the operating mode of the window blind 1. First, let the two cord winding assemblies 100 be arranged in the headrail 2 at intervals, and make the cord winding holes 15 of the two bases 10 of the two cord winding assemblies 100 correspond to the two cord insertion holes 200 of the headrail 2 respectively. Then, the two rotating members 20 of the two cord winding assemblies 100 are driven by the rotation of the pivoting drive 5 to drive the rotating rod 4 to rotate accordingly. Then, make the one ends of the two lift cords 8 pass through the ring-shaped cord guides 17 of the second cord winding holes 15 of the two bases 10 and respectively, and respectively wind them on the outer peripheral walls 201 of the two rotating members 20 in at least one turn to form a reserved section, and then, let the said one ends of the two lift cords 8 respectively pass along the two lead angle sections 271 of the two rotating members 20 and pass through the two openings 27 of the two rotating members 20 and the knot holes 31 of the sliding guides 30 and be tied and fixed to the knot holes 31. Finally, let the other ends of the two lift cords 8 pass through the two cord insertion holes 200 of the headrail 2 and the blind body 6 in sequence, and then fix them on the bottom rail 7.

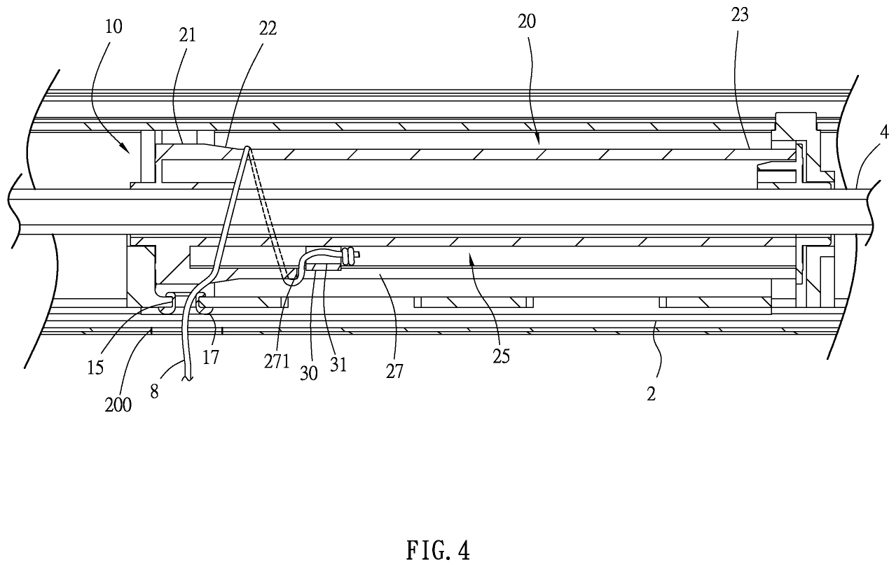

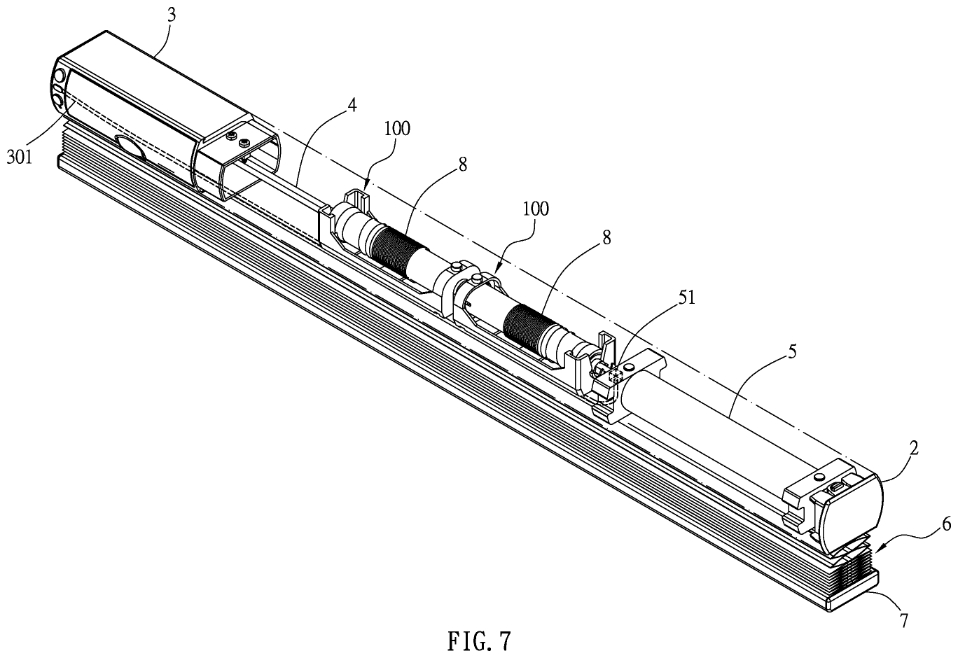

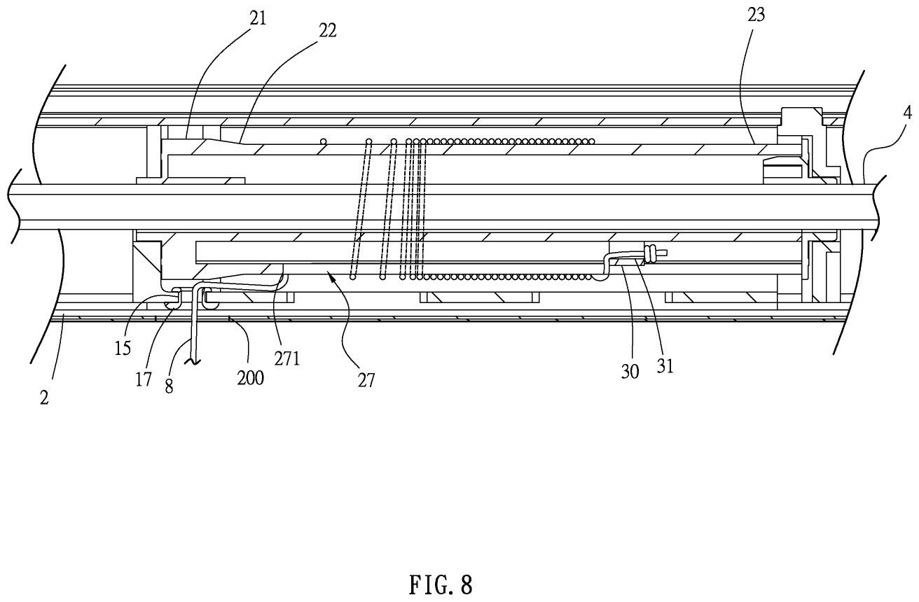

In summary, please refer to FIG. 2, FIG. 4, FIG. 7 and FIG. 8. When the operator wants to collapse the blind body 6 of the window blind 1 and the bottom rail 7 upwards, first press the control device 3 and use the electrical wire 301 to electrically control the micro-control unit 51 of the pivoting drive 5, so that the micro-control unit 51 of the pivoting drive 5 generates a folding signal that causes the pivoting drive 5 to drive the rotating rod 4 to rotate (in this embodiment, when the axis of the rotating rod 4 rotates clockwise, it is defined as the blind body 6 of the window blind 1 and the bottom rail 7 are in an upwardly folding collapsed state). The two rotating members 20 of the two cord winding assemblies 100 are driven by the rotation of the pivoting drive 5 to drive the rotating rod 4 to rotate accordingly, so that the two lift cords 8 are gradually wound in the outer peripheral walls 201 of the two rotating members 20 respectively. Subject to the technical feature that the cord-guide segments 22 of the rotating members 20 gradually converge from the respective large-diameter ends 21 toward the respective small-diameter ends 23, as the number of windings of the two lift cords 8 on the outer peripheral walls 201 of the two rotating members 20 is gradually increasing, the several rope segments wound on the cord-guide segments 22 of the two rotating members 20 are smoothly arranged in the direction of the respective small-diameter ends 23. As a result, the system gradually generates a force sufficient to push the sliding guides 30 located in the guide sliding portions 25 of the two rotating members 20 to slide toward the respective small-diameter ends 23, and increases the margin that the two lift cords 8 can be wound on the outer peripheral walls 201 of the two rotating members 20. At this time, because the bottom rail 7 is tied to the other ends of the two lift cords 8, the bottom rail 7 drives the blind body 6 to gradually close in the direction of the headrail 2. Until the operator presses the control device 3 again and stops the pivoting drive 5 from rotating, the two rotating members 20 of the two cord winding assemblies 100 and the rotating rod 4 will no longer be subjected to the rotation of the pivoting drive 5, thereby achieving the effect of the blind body 6 folding and collapsing.

Continuing, please refer to FIG. 1 to FIG. 8 together. When the operator wants to expand the blind body 6 of the window blind 1 and the bottom rail 7 downwards, after pressing the control device 3 again and using the electrical wire 301 to electrically control the micro-control unit 51 of the pivoting drive 5, the micro-control unit 51 of the pivoting drive 5 generates an unfolding signal so that the pivoting drive 5 drives the rotating rod 4 to rotate again (in this embodiment, when the axis of the rotating rod 4 rotates counter-clockwise, it is defined as the blind body 6 of the window blind 1 and the bottom rail 7 are in a downwardly unfolded state). The two rotating members 20 of the two cord winding assemblies 100 are driven by the rotation of the pivoting drive 5 to drive the rotating rod 4 to rotate accordingly. At this time, because the cord segments of the two lift cords 8 originally wound on the respective outer peripheral walls 201 of the two rotating members 20 are gradually released, the respective other ends of the two lift cords 8 can be used stretched again by the bottom rail 7 and move downwards away from the bottom of the headrail 2. At this time, the two sliding guides 30 of the two cord winding assemblies 100 are respectively made to return from the position close to the respective small-diameter ends 23 of the two rotating members 20 to the initial direction of the respective large-diameter ends 21, letting the blind body 6 match the predetermined length stretched by the respective other ends of the two lift cords 8 and present the unfolded state again. Until the operator presses the control device 3 again and electrically controls the micro-control unit 51 of the pivoting drive 5 through the electrical wire 301, the micro-control unit 51 of the pivoting drive 5 generates a stop signal to stop the pivoting drive 5, so that the two rotating members 20 of the two cord winding assemblies 100 and the rotating rod 4 will no longer be rotated by the pivoting drive 5, thereby achieving the effect of extending out the blind body 6.

The above is the operating mode of the window blind 1 and its components disclosed in the first preferred embodiment of the present invention when being folded upward or unfolded downward. Compared with the previous technology, its effects are:

1. Subject to the technical feature of making the one ends of the two lift cords 8 pass through the ring-shaped cord guides 17 of the second cord winding holes 15 of the two bases 10 and respectively, and respectively wind them on the outer peripheral walls 201 of the two rotating members 20 in at least one turn to form a reserved section, and then, letting the said one ends of the two lift cords 8 respectively pass along the two lead angle sections 271 of the two rotating members 20 and pass through the two openings 27 of the two rotating members 20 and the knot holes 31 of the sliding guides 30 and be tied and fixed to the knot holes 31, and finally, letting the other ends of the two lift cords 8 pass through the two cord insertion holes 200 of the headrail 2 and the blind body 6 in sequence, and then fix them on the bottom rail 7, when the blind body 6 of the window blind 1 is fully unfolded, in addition to allowing the lift cord 8 to be reduced by the clamping between the sliding guide 30 and the opening 27 of the respective rotating member 20, it can also prevent the two lift cords 8 from being pushed down to break by the blind body 6 and the bottom rail 7, which greatly increases the service life of the window blind 1.

2. Subject to the technical feature that the sliding guide 30 of each cord winding assembly 100 is located in the guide sliding portion 25 in the inner peripheral wall 203 of the respective rotating member 20, when the blind body 6 of the window blind 1 is in an unfolded state or a folded state, the lift cord 8 wound on the outer peripheral wall 201 of the associating rotating member 20 will not be interfered by the associating sliding guide 30, thereby improving the convenience of winding and unwinding the lift cord 8 on the outer peripheral wall 201 of the associating rotating member 20.

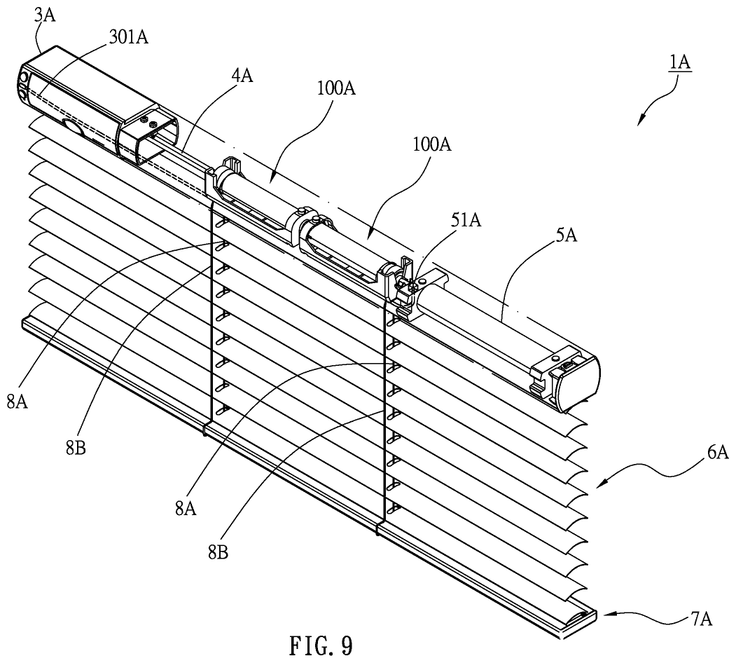

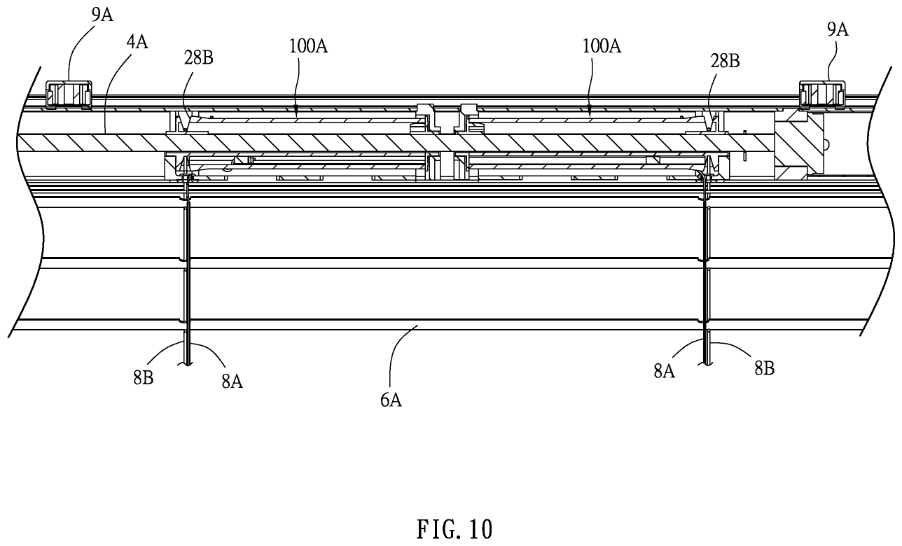

Please refer to FIGS. 9 and 10, which are another type of window blind 1A disclosed in the second preferred embodiment of the present invention (for example, venetian blind). The window blind 1A comprises a headrail 2A, a control device 3A, a rotating rod 4A, a pivoting drive 5A, a blind body 6A composed of a plurality of slats, a bottom rail 7A, two lift cords 8A, two tilt cords 8B, two mounting brackets 9A, and two cord winding assemblies 10A. The control device 3A is installed on one end of the headrail 2A. The rotating rod 4A, the pivoting drive 5A and the two cord winding assemblies 10A are all contained in the headrail 2A. The control device 3A is electrically connected to a micro-control unit 51A in the pivoting drive 5A through an electrical wire 301A, and the pivoting drive 5A is electrically controlled by the micro-control unit 51A to generate a pivoting movement. One end of the rotating rod 4A is connected to the pivoting drive 5A and is pivoted by the pivoting drive 5A to produce movement. The other end of the rotating rod 4A is sequentially inserted through the two tube-like rotating members 20A of the two cord winding assemblies 100A, so that the two rotating members 20A of the two cord winding assemblies 100A are driven by the rotation of the pivoting drive 5A to drive the rotating rod 4A to rotate accordingly. One side of the blind body 6A is connected to the bottom of the headrail 2A, and the bottom rail 7A is connected to the other side of the blind body 6A, so that the blind body 6A is between the headrail 2A and the bottom rail 7A. The two lift cords 8A have the respective one ends thereof respectively tied to the two cord winding assemblies 100A, and the respective other ends thereof respectively fixed to the bottom rail 7A after passing through the bottom of the headrail 2A and the slats of the blind body 6A. The two mounting brackets 9A are separately attached to the headrail 2A and used to provide the headrail 2A to be fixed on the external wall or window frame. It is worth mentioning that the system can only set one mounting bracket 9A. Similarly, any one of the cord winding assemblies 100A comprises a long base 10A, a long rotating member 20A cooperating with the base 10A and a sliding guide 30A. Since the technical features and effects of each component of the window blind 1A are the same as the first preferred embodiment disclosed above, we will no longer focus on this here.

The window blind 1A disclosed in the second preferred embodiment of the present invention is different from the window blind 1 disclosed in the first preferred embodiment in that the position of the outer peripheral wall 201A of the rotating member 20A of any one of the two cord winding assemblies 100A close to the respective large-diameter end 21A is recessed to form a position-limiting portion 28B. One end of the tilt cord 8B is connected to the position-limiting portion 28B of the associating rotating member 20A and is rotated by the rotation of the associating rotating member 20A. The other end of the tilt cord 8B is sequentially connected to the plurality of slats of the blind body 6A and fixed to the bottom rail 7A. The window blind 1A disclosed in the second preferred embodiment of the present invention (for example, venetian blind) and the effects to be achieved by its components are all known techniques, and are no longer inked here.

What is claimed is:

1. A cord winding assembly (100), comprising:
a base (10) comprising a first pivot portion (11), a second pivot portion (13), and a cord winding hole (15) cut through a bottom side thereof and disposed close to said first pivot portion (11);
a rotating member (20) being a long hollow tube member configured to form an outer peripheral wall (201) and an inner peripheral wall (203), said outer peripheral wall (201) comprising a large-diameter end (21) and a small-diameter end (23) respectively pivoted to said first pivot portion (11) and said second pivot portion (13) of said base (10), said outer peripheral wall (201) of said rotating member (20) being recessed in the direction of said inner peripheral wall (203) to form a guide sliding portion (25) and an opening (27) communicating with said guide sliding portion (25), said guide sliding portion (25) being connected to the outside world through said opening (27), the peripheral wall of the aperture of said opening (27) that is close to said large-diameter end (21) forming a lead angle section (271); and
a sliding guide (30) pivoted on said guide sliding portion (25) of said rotating member (20).

2. The cord winding assembly (100) as claimed in claim 1, wherein said guide sliding portion (25) is concave along the long axis of said rotating member (20); said opening (27) is an elongated opening extended from said small-diameter end (23) toward said large-diameter end (21).

3. The cord winding assembly (100) as claimed in claim 2, wherein said cord winding hole (15) of said base (10) is mounted with a ring-shaped cord guide (17).

4. The cord winding assembly (100) as claimed in claim 3, wherein said rotating member (20) further comprises a cord-guide segment (20) surrounding said outer peripheral wall (201) and connected to said large-diameter end (21), said cord-guide segment (22) gradually converging from said large-diameter end (21) toward said small-diameter end (23).

5. A window blind (1), comprising a headrail (2), a control device (3), a rotating rod (4), a pivoting drive (5), a blind body (6), a bottom rail (7), two lift cords (8) and two cord winding assemblies (100) as claimed in claim 4, said control device (3) being installed on one end of said headrail (2), said rotating rod (4), said pivoting drive (5) and said two cord winding assemblies (100) being all contained in said headrail (2), said control device (3) being electrically connected to a micro-control unit (51) in said pivoting drive (5) so that said pivoting drive (5) is electrically controlled by said micro-control unit (51), said rotating rod (4) having one end thereof connected to said pivoting drive (5) and pivotable by said pivoting drive (5) and an opposite end thereof inserted through said rotating members (20) of said two cord winding assemblies (100), said blind body (6) having one side thereof connected to said headrail (2), said bottom rail (7) being connected to an opposite side of said blind body (6), said two lift cords each having one end thereof tied to the said sliding guide (30) of one respective said cord winding assembly (100) and an opposite end thereof extending along said lead angle section (271) of said opening (27) of the respective said rotating members (20) and passing through a cord insertion hole (200) of said headrail (2) and said blind body (6) and then fixed on said bottom rail (7).

6. The window blind (1) as claimed in claim 5, wherein said sliding guide (30) of each said cord winding assembly (100) is provided with a knot hole (31), and the said one end of each said lift cord (8) is tied to the position of said knot hole (31) of the respective said sliding guide (30).

7. The window blind (1) as claimed in claim 6, further comprising a mounting bracket (9) attached to said headrail (2).

8. A window blind (1A), comprising a headrail (2A), a control device (3A), a rotating rod (4A), a pivoting drive (5A), a blind body (6A), a bottom rail (7A), two lift cords (8A), two tilt cords (8B) and two cord winding assemblies (100A) as claimed in claim 4, said control device (3A) being installed on one end of said headrail (2A), said rotating rod (4A), said pivoting drive (5A) and said two cord winding assemblies (100A) being all contained in said headrail (2A), said control device (3A) being electrically connected to a micro-control unit (51A) in said pivoting drive (5A) so that said pivoting drive (5A) is electrically controlled by said micro-control unit (51A), said rotating rod (4A) having one end thereof connected to said pivoting drive (5A) and pivotable by said pivoting drive (5A) and an opposite end thereof inserted through said rotating members (20A) of said two cord winding assemblies (100A), said blind body (6A) having one side thereof connected to said headrail (2A), said bottom rail (7A) being connected to an opposite side of said blind body (6A), said two lift cords each having one end thereof tied to the said sliding guide (30A) of one respective said cord winding assembly (100A) and an opposite end thereof extending along said lead angle section (271A) of said opening (27A) of the respective said rotating members (20A) and passing through one respective cord insertion hole (200A) of said headrail (2A) and said blind body (6A) and then fixed on said bottom rail (7A), wherein the position of said outer peripheral wall (201A) of said rotating member (20A) of each said cord winding assembly (100A) close to the respective said large-diameter end (21A) is recessed to form a position-limiting portion (28B); each said tilt cord (8B) has one end thereof connected to the said position-limiting portion (28B) of the said rotating member (20A) of one respective said cord winding assembly (100A) and an opposite end thereof inserted through said cord insertion hole (200A) of said headrail (2A) and connected to a plurality of slats of said blind body (6A) and fixed to said bottom rail (7A).

9. The window blind (1A) as claimed in claim 8, wherein said sliding guide (30A) of each said cord winding assembly (100A) is provided with a knot hole (31A), and the said one end of each said lift cord (8A) is tied to the position of said knot hole (31A) of the respective said sliding guide (30A).

10. The window blind (1A) as claimed in claim 9, further comprising a mounting bracket (9A) attached to said headrail (2A).
